(19) United States
(12) Patent Application Publication
(10) Pub. No.: US 2025/0168748 A1
(43) Pub. Date: May 22, 2025

(54) INFORMATION TRANSCEIVING METHOD, INFORMATION PROCESSING METHOD AND APPARATUSES THEREOF

(71) Applicant: FUJITSU LIMITED, Kawasaki-shi, Kanagawa (JP)

(72) Inventor: Yang LU, Beijing (CN)

(73) Assignee: FUJITSU LIMITED, Kawasaki-shi, Kanagawa (JP)

(21) Appl. No.: 19/028,669

(22) Filed: Jan. 17, 2025

Related U.S. Application Data
(63) Continuation of application No. PCT/CN2022/110719, filed on Aug. 5, 2022.

(51) Int. Cl. H04W 48/08; H04W 76/10

(52) U.S. Cl. CPC H04W 48/08; H04W 76/10

(57) ABSTRACT

An information transceiving apparatus, applicable to a first network device to which a first cell belongs, includes: a transmitter configured to transmit third indication information to a second network device, the third indication information being used to indicate the first network device to transmit a first synchronization signal block (SSB) of the first cell that should be transmitted.

### CROSS-REFERENCE TO RELATED APPLICATION

This application is a continuation application of International Application PCT/CN2022/110719 filed on Aug. 5, 2022, and designated the U.S., the entire contents of which are incorporated herein by reference.

### TECHNICAL FIELD

This disclosure relates to the field of communication technologies.

### BACKGROUND

As a NR (New Radio) base station needs to operate at large a bandwidth (such as 100 MHz), a large number of ports (64T/64R) and shorter TTIs (transmission time intervals) (such as 1 ms) need to be used, the NR base station has significantly higher energy consumption overhead in baseband processing, digital front-end, and other functions compared to an LTE (long-term evolution) base station. Moreover, an FR2 (frequency range 2) operating frequency of NR is relatively high (>6 GHz), and the higher the frequency, the greater a pathloss of a signal. Therefore, a design principle of NR is to use a narrower beam to transmit the signal farther. In this way, the number of antenna units used by the NR base station for analog beamforming will greatly increase, resulting in increases in the numbers of RF units and RF channels for transmitting and receiving signals. Each RF channel is equipped with a power amplifier (PA), which accounts for about 80% of the total energy consumption of the base station, and as the number of PAs increases, the energy consumption of the base station also increases. A current FR1 (frequency range 1) frequency band AAU (active antenna unit) generally uses 192 antenna units and supports 64 channels, which is much larger than a maximum of 8 channels of LTE.

According to data statistics of operators, average energy consumption of an NR base station exceeds three times that of an LTE base station, and nearly 50% of the cost an operator to deploy 5G (5th generation) networks is electricity expenses. More importantly, an NR base station still incurs significant energy consumption even during periods of no service, as it still needs to transmit common signals even if there is no service, such as SSBs (synchronization signal blocks), SIB1 (first system information block), and SI (system information), etc., thereby greatly reducing energy efficiency of the NR base station. Energy saving of NR networks is an urgent issue that needs to be addressed.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In 3GPP Rel-15/Rel-16 (3rd Generation Partnership Project Release 15/Release 16), it is supported that in an intra-band carrier aggregation (CA) scenario, a secondary cell (SCell) of a terminal equipment may not transmit synchronization signal blocks (SSBs), and the terminal equipment obtains downlink synchronization of the SCell from SSBs transmitted by a special cell (SpCell). At the same site, at least one cell transmits SSBs, and only a cell that transmits SSBs may serve as the SpCell of terminal equipment.

It was found by the inventors that in the related art, at least one of cells in the same site must transmit SSBs, and in addition, a serving cell (at least the SpCell) of the terminal equipment must transmit SSBs. Hence, even when there is no service at the site, energy cost is still high, which is not conducive to energy saving of the network.

Furthermore, for energy saving of the network, even if all serving cells of the terminal equipment stop transmitting SSBs or extend transmission periods of SSBs, it means that the terminal equipment loses downlink synchronization and downlink channel estimation signals of the serving cells, that is, the terminal equipment is unable to perform measurement based on the SSBs of the serving cells. Therefore, the serving cells of the terminal equipment are unable to serve for the terminal equipment. A terminal equipment originally connected to the serving cells must be handed over to a neighboring cell, and a terminal equipment originally camped on the serving cells performs cell reselection to camp on the neighboring cell. FIG. 1 is a schematic diagram of energy saving scheme of a network. As shown in FIG. 1, for energy saving of the network, for the SpCell of the terminal equipment, the network device may dynamically activate and deactivate based on traffics, measurement reports and other information of an NR cell and its neighboring cell. When a cell is deactivated, transmission of synchronization signal blocks and system information is stopped, and reception of uplink signals transmitted by the terminal equipment is stopped. In this way, in case of lower traffics, energy consumption of the SpCell may be saved.

Thus, when the cell enters an energy-saving state, the terminal equipment is handed over to the neighboring cell and inform a NR neighboring network device or LTE network device that the NR cell has entered the energy-saving state. The neighboring NR/LTE network device undertakes a coverage area and traffics of the NR cell. Afterwards, the neighboring NR/LTE network devices determine whether to request the NR cell that has entered the energy-saving state to resume normal operations according to their own traffic, and measurement reports, etc. For example, when their own traffic reaches a threshold, they trigger requesting the NR cell that has entered the energy-saving state to resume normal operations. When the NR cell resumes normal operations, some terminal equipments that were previously switched to a neighboring NR/LTE cell may be switched back to the NR cell.

It was found by the inventors that in the above scheme, when the NR cell dynamically enters the energy-saving state for multiple times, the terminal equipment also is frequently switched out of the NR cell or frequently perform cell reselection, thereby affecting user experiences. In addition, migration of the terminal equipment of the cell in the energy-saving state to the neighboring cell inevitably increases a load level of the neighboring cell, and affect service quality of the terminal equipment of the neighboring cell.

In order to solve at least one of the above problems, embodiments of this disclosure provide an information transceiving method, an information processing method and apparatuses thereof.

According to one aspect of the embodiments of this disclosure, there is provided an information transceiving apparatus, configured in a first network device to which a first cell belongs, the apparatus including:
a first transmitting unit configured to transmit third indication information to a second network device, the third indication information being used to indicate the first network device to stop or resume transmitting a first synchronization signal block of the first cell that should be transmitted, or being used to indicate the first network device to stop or resume transmitting a physical broadcast channel (PBCH) carrying a master information block (MIB) of a first synchronization signal block that should be transmitted.

According to another aspect of the embodiments of this disclosure, there is provided an information transceiving apparatus, configured in a second network device, the apparatus including:
a first receiving unit configured to receive third indication information transmitted by a first network device, the third indication information being used to indicate the first network device to stop or resume transmitting a first synchronization signal block of a first cell that should be transmitted, or being used to indicate the first network device to stop or resume transmitting a physical broadcast channel (PBCH) carrying a master information block (MIB) of the first synchronization signal block that should be transmitted.

According to a further aspect of the embodiments of this disclosure, there is provided an information processing apparatus, configured in a terminal equipment, the apparatus including:
a second receiving unit configured to receive a discovery reference signal transmitted by a network side device; and
a first processing unit configured to perform downlink reception of a reference signal of a first cell or determine a measurement result of a first cell according to the discovery reference signal;
wherein the discovery reference signal is a synchronization reference signal (SS) contained in a first synchronization signal block of the first cell.

An advantage of the embodiments of this disclosure exists in that the terminal equipment may perform downlink reception of the reference signal of the energy-saving cell or determine the measurement result of the energy-saving cell according to the discovery reference signal, and the terminal equipment may perform random access, RLM/BFD/RRM measurement and measurement for cell selection or reselection in the energy-saving cell. Thus, the terminal equipment is not necessarily handed over to other cells, and the terminal equipment originally camping on the energy-saving cell does not necessarily perform cell reselection. This may avoid service interruption and increase of the load level of the neighboring cell resulted from migrating the terminal equipment of the energy-saving cell to the neighboring cell, and ensure that user experiences are not reduced when the cell enters the energy-saving state.

An advantage of the embodiments of this disclosure exists in that the indication information on whether to stop transmitting SSBs may be exchanged between the network devices, so that the neighboring base station of the energy-saving cell may broadcast the exchanged information to the terminal equipment via the system information, thereby enabling the terminal equipment to detect the energy-saving cell, and perform RRM measurement on the energy-saving cell by using the discovery reference signal or the reference signal of the second cell.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/including/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of a communication system of embodiments of this disclosure;

FIG. 2 is a schematic diagram of a distributed network energy-saving scheme;

FIG. 3 is a schematic diagram of an information processing method of embodiments of this disclosure;

FIG. 4 is a schematic diagram of an information transmitting of embodiments of this disclosure;

FIG. 5 is another schematic diagram of an information transmitting method of embodiments of this disclosure;

FIG. 6 is a schematic diagram of an information transceiving method of embodiments of this disclosure;

FIG. 7 is another schematic diagram of an information transceiving method of embodiments of this disclosure;

FIG. 8 is a schematic diagram of an information transceiving apparatus of embodiments of this disclosure;

FIG. 9 is another schematic diagram of an information transceiving apparatus of embodiments of this disclosure;

FIG. 10 is a further schematic diagram of an information transceiving apparatus of embodiments of this disclosure;

FIG. 11 is a schematic diagram of an information processing apparatus of embodiments of this disclosure;

FIG. 12 is a schematic diagram of a network device of embodiments of this disclosure; and

FIG. 13 is a schematic diagram of a terminal equipment of embodiments of this disclosure.

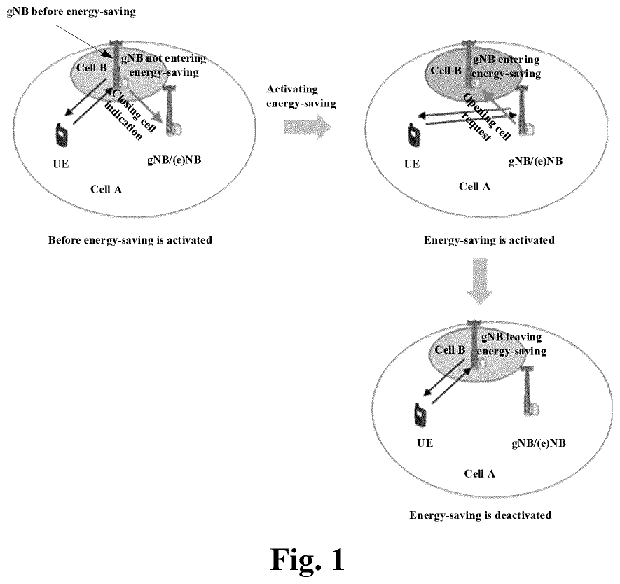

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G, and new radio (NR), etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.), an IAB (integrated access and backhaul) node or an IAB-DU or an IAB-donor. The term “base station” may include some or all of its functions, and each base station may provide communication coverage for a specific geographical area. And a term “cell” may refer to a base station and/or its coverage area, depending on a context of the term. Without causing confusion, the term “cell” and the term “base station” are interchangeable.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” may refer to a network device, and may also refer to a terminal equipment, except otherwise specified.

In the following description, without causing confusion, the terms “uplink control signal” and “uplink control information (UCI)” or “physical uplink control channel (PUCCH)” are interchangeable, and terms “uplink data signal” and “uplink data information” or “physical uplink shared channel (PUSCH)” are interchangeable.

The terms “downlink control signal” and “downlink control information (DCI)” or “physical downlink control channel (PDCCH)” are interchangeable, and the terms “downlink data signal” and “downlink data information” or “physical downlink shared channel (PDSCH)” are interchangeable.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, higher-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

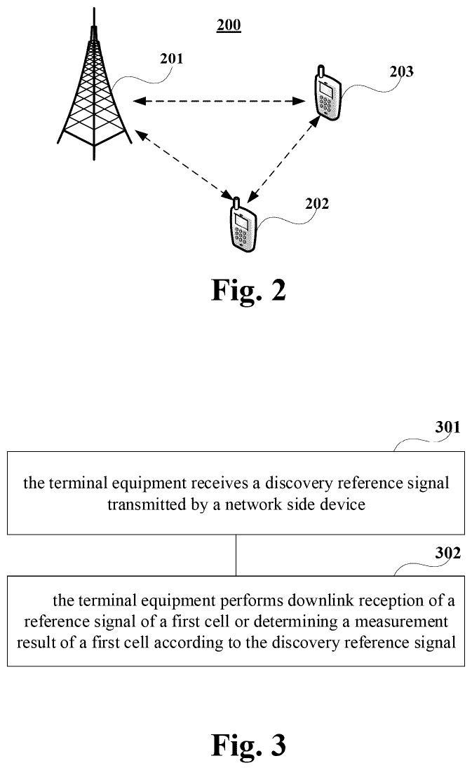

FIG. 2 is a schematic diagram of a communication system of embodiments of this disclosure, in which a case where terminal equipment and a network device are taken as examples is schematically shown. As shown in FIG. 2, the communication system 200 may include a network device 201 and terminal equipment 202, 203. For the sake of simplicity, an example having only two terminal equipment and one network device is schematically given in FIG. 2; however, the embodiments of this disclosure are not limited thereto.

In the embodiments of this disclosure, existing services or services that may be implemented in the future may be performed between the network device 201 and the terminal equipments 202, 203. For example, such services may include but not limited to an enhanced mobile broadband (eMBB), massive machine type communication (mMTC), and ultra-reliable and low-latency communication (URLLC), etc.

The terminal equipment 202 may transmit data to the network device 201, such as in a granted or grant-free transmission manner. The network device 201 may receive data transmitted by one or more terminal equipment 202 and feed back information to the terminal equipment 202, such as acknowledgement (ACK)/non-acknowledgement (NACK) information. According to the feedback information, the terminal equipment 202 may acknowledge end of a transmission process, or may perform new data transmission, or may perform data retransmission.

It should be noted that FIG. 2 shows that two terminal equipment 202, 203 are both in coverage of the network device 201. However, this disclosure is not limited thereto, and the two terminal equipment 202, 203 may not be in coverage of the network device 201, or one terminal equipment 202 is in coverage of the network device 201 and the other terminal equipment 203 is out of coverage of the network device 201.

Embodiments of this disclosure shall be described below with reference to implementations and the accompanying drawings.

### Embodiments of a First Aspect

The embodiments of this disclosure provide an information processing method, which shall be described from a terminal equipment side.

FIG. 3 is a schematic diagram of the information processing method of the embodiments of this disclosure, applicable to a terminal equipment. As shown in FIG. 3, the method includes:
301: the terminal equipment receives a discovery reference signal transmitted by a network side device; and
302: the terminal equipment performs downlink reception of a reference signal of a first cell or determining a measurement result of a first cell according to the discovery reference signal; wherein the discovery reference signal is a synchronization reference signal (SS) contained in a first synchronization signal block of the first cell.

It should be noted that FIG. 3 only schematically illustrates the embodiments of this disclosure; however, this disclosure is not limited thereto. For example, some other steps may be added, or some steps therein may be reduced. And appropriate variants may be made by those skilled in the art according to the above contents, without being limited to what is contained in FIG. 3.

In some embodiments, when there is no service, the network side may stop transmitting synchronization signal blocks of one or more serving cells of the terminal equipment or physical broadcast channels (PBCHs) of the synchronization signal blocks carrying master information blocks (MIBs) of one or more serving cells of the terminal equipment, or extend transmission periods of the synchronization signal blocks (such as from 20 ms to 320 ms), or extend transmission periods of the PBCHs of the synchronization signal blocks. Below, stopping transmitting the synchronization signal blocks may also refer to extending periods of the synchronization signal blocks, and stopping transmitting the PBCHs may also refer to extending periods of the PBCHs. Below, the synchronization signal blocks of the first cell (also referred to as a first carrier) are referred to as first synchronization signal blocks, and the first cell is a serving cell stopping transmitting the synchronization signal blocks or a serving cell stopping transmitting the physical broadcast channels (PBCHs) of the synchronization blocks carrying the master information blocks (MIBs). The first cell may be a special cell (such as a primary cell PCell or a primary secondary cell PSCell), or a non-special cell (such as a SCell), of the terminal equipment. For example, the first cell is a special cell (SpCell) of the terminal equipment when it is in a connected state, or a cell selected or reselected by the terminal equipment when it is in an idle or inactive state; however, the embodiments of this disclosure are not limited thereto. Thus, energy consumption of the network side may be saved. Therefore, the first cell may also be referred to as an energy-saving cell (or an SSB-less cell). The synchronization signal blocks (also referred to as synchronization signal and PBCH blocks, abbreviated as SSBs) may include a primary synchronization signal (PSS), a secondary synchronization signal (SSS), and/or a physical broadcast channel (PBCH).

In some embodiments, a synchronization signal block of a second cell (also referred to as a second carrier) is referred to as a second synchronization signal block, and the second cell may be a special cell (such as a primary cell PCell or a primary secondary cell PSCell), or a non-special cell (such as an SCell), of the terminal equipment. The second cell may also be referred to as a reference cell or an anchor cell; however, the embodiments of this disclosure are not limited thereto. In the embodiments of this disclosure, there exists no QCL relationship between the first SSB of the first cell and a second SSB of the second cell with an index identical thereto, and as the first SSB has been stopped transmitting, the terminal equipment is unable to perform downlink reception of the reference signal of the first cell or determine the measurement result of the first cell according to the first SSB or the second SSB.

In some embodiments, in order to perform downlink reception of the reference signal of the first cell or determine the measurement result of the first cell, the network side device may transmit a discovery reference signal, which is a synchronization reference signal (SS) contained in the first SSB of the first cell, the synchronization reference signal including a PSS and/or an SSS. For example, the network side device may stop transmitting the first SSB, but transmit the discovery reference signal separately; or, the network device may stop transmitting a physical broadcast channel (PBCH) of the first SSB carrying a master information block (MIB), but continue to transmit the synchronization reference signal in the first SSB.

In some embodiments, the first synchronization signal block of the first cell is in a quasi-colocation QCL relationship with the discovery reference signal, types of the QCL relationship including QCL type C and QCL type D. The first synchronization signal block and the discovery reference signal in the quasi-colocation relationship have identical index. In other words, the first SSB and the discovery reference signal having an identical index are in a quasi-colocation relationship. The quasi-colocation relationship may be indicated by second indication information, which shall be described later.

In some embodiments, when the terminal equipment fails to receive the first synchronization signal block transmitted by the network side device (the first SSB of the first cell is stopped transmitting) or fails to receive the PBCH of the first synchronization signal block, the discovery reference signal may provide downlink channel estimation information for the first cell, or, in other words, the terminal equipment may perform downlink reception of the reference signal of the first cell or determine the measurement result of the first cell according to the discovery reference signal, and the terminal equipment may perform random access, CSI-RS-based or SSB-based RLM/BFD/RRM, and measurement for cell selection or reselection in the first cell. Hence, terminal equipment is not necessarily handed over to other cells, and a terminal equipment originally camping on the first cell does not necessarily perform cell reselection, which may avoid service interruption and increase of a load level of a neighboring cell resulted from migrating the terminal equipment of the cell in the energy-saving state to the neighboring cell, and ensure that user experiences are not reduced when the cell enters the energy-saving state.

In some embodiments, by transmitting first indication information, the network side device may indicate that the network side device stops transmitting the first SSB of the first cell that should have been transmitted, or indicate that the network side device stops transmitting the PBCH carrying the MIB of the first SSB that should have been transmitted. When the first indication information is not transmitted, it indicates that all SSBs that should actually be transmitted are transmitted normally. The first indication information may be denoted by one or more bits, and is also used to indicate an index of the stopped transmitted first synchronization signal that should have been transmitted or an index of the first synchronization signal block of which the stopped transmitted PBCH carrying the MIB that should have been transmitted. The network device of the first cell may transmit the first indication information before stopping transmitting the first SSB and system information or before stopping transmitting the physical broadcast channel (PBCH) of the first synchronization signal block carrying the master information block (MIB) and system information. The first indication information may be carried by the system information or a dedicated RRC message.

For example, the first indication information may be a newly-added information element in the system information or dedicated RRC message. When the system information or dedicated RRC signaling does not include the newly-added information element, it indicates that all SSBs of the first cell that should have been transmitted are transmitted normally, and when the system information or dedicated RRC signaling includes the newly-added information element, it indicates that the first SSB of the first cell or the PBCH of the first SSB carrying the MIB that should have been transmitted is stopped transmitting, a value of the information element being used to indicate an index of the first SSB that is stopped transmitting. For example, the information element may be denoted by a bitmap, each bit of the bitmap corresponding to an index of an SSB. If a value of the bit is 1, it indicates that the SSB with the index is transmitted normally, and if the value of the bit is 0, it indicates that the SSB with the index is stopped transmitting, and vice versa; or, the information element may also use values of N bits to indicate indices of the SSBs that are stopped transmitting; however, the embodiments of this disclosure are not limited thereto.

In some embodiments, by transmitting second indication information, the network side device may indicate that the terminal equipment is able to perform downlink reception of the reference signal of the first cell or determine the measurement result of the first cell according to the discovery reference signal. When the terminal equipment receives the second indication information, it indicates that the terminal equipment is able to perform downlink reception of the reference signal of the first cell or determine the measurement result of the first cell according to the discovery reference signal, and when the terminal equipment does not receive the second indication information, it indicates that the terminal equipment is unable to perform downlink reception of the reference signal of the first cell or determine the measurement result of the first cell according to the discovery reference signal. If the terminal equipment needs to perform downlink reception of the reference signal of the first cell or determine the measurement result of the first cell, it needs to transmit a wake-up signal to enable the first SSB to be resumed transmitting. Embodiments of the wake-up signal shall be described in embodiments of a second aspect.

Or, in some embodiments, the second indication information is used to indicate that the first synchronization signal block is in a quasi-colocation relationship with the discovery reference signal, so that the terminal equipment performs downlink reception of the reference signal of the first cell or determine the measurement result of the first cell according to the discovery reference signal.

In some embodiments, before stopping transmitting the first SSB or before stopping transmitting the PBCH of the first SSB carrying the MIB and the system information, the network device of the first cell may transmit the second indication information, which may be carried by the system information or the dedicated RRC message.

For example, the second indication information may be a newly-added information element in the system information or the dedicated RRC message. When the system information or dedicated RRC signaling does not include the information element, it indicates that the terminal equipment is unable to perform downlink reception of the reference signal of the first cell or determine the measurement result of the first cell according to the discovery reference signal, and when the system information or dedicated RRC signaling includes the information element, it indicates that the terminal equipment is able to perform downlink reception of the reference signal of the first cell or determine the measurement result of the first cell according to the discovery reference signal.

For example, the newly-added information element may be a quasi-colocation identification information element, and include identification information of the discovery reference signal to indicate that the first synchronization signal block of the first cell and the discovery reference signal are in a quasi-colocation relationship. When the system information or dedicated RRC signaling includes the information element, it indicates that the terminal equipment is able to perform downlink reception of the reference signal of the first cell or determine the measurement result of the first cell according to the discovery reference signal.

In some embodiments, the second indication information further includes configuration information of the discovery reference signal, wherein the configuration information of the discovery reference signal includes at least one of a center frequency point, a subcarrier spacing, a transmission period of the discovery reference signal, of the reference signal or an index of a reference signal transmitted within a transmission period. That is, before transmitting the discovery reference signal, the network device may also transmit the configuration information of the discovery reference signal, and the terminal equipment may receive the discovery reference signal on a corresponding resource according to the configuration information.

For example, the newly-added information element may be a quasi-colocation identification information element, and include configuration information of the discovery reference signal to indicate that the first synchronization signal block of the first cell and the discovery reference signal are in a quasi-colocation relationship. When the system information or dedicated RRC signaling includes the information element, it indicates that the terminal equipment may perform downlink reception of the reference signal of the first cell or determine the measurement result of the first cell according to the discovery reference signal.

Optionally, when the configuration information of the discovery reference signal indicated by the second indication information is broadcast via system information of the second cell or the neighboring cell of the first cell, the configuration information of the discovery reference signal may further include a synchronization timing offset between the first cell and the second cell, or a synchronization timing offset between the first cell and the neighboring cell, in units of half-frames.

It should be noted that the above-described network side device that transmits/stops transmitting the first SSB of the first cell or the PBCH of the first SSB carrying the MIB and the network side device that transmits the discovery reference signal may be identical or different network devices, and the above-described network side device that transmits the first indication information and second indication information and receives the wake-up signal and the network side device that transmits the discovery reference signal may be identical or different network devices.

In addition, the above-described network side device transmitting the discovery reference signal may also exchange the first indication information and/or the second indication information with a neighboring network device, and the neighboring network device may further transmit the first indication information and/or the second indication information via the system information or dedicated RRC message to a terminal equipment of a neighboring cell or a terminal equipment receiving the discovery reference signal; however, the embodiments of this disclosure are not limited thereto, and details shall be described in embodiments of a fifth aspect.

In some embodiments, as described above, when the terminal equipment receives the second indication information, it may perform downlink reception of the reference signal of the first cell or determine the measurement result of the first cell according to the discovery reference signal, and perform random access, RLM/BFD/RRM measurement, and measurement for cell selection and/or reselection, etc., on the first cell according to the measurement result. That is, when the terminal equipment needs to perform random access, RLM/BFD/RRM measurement, and measurement for cell selection and/or reselection on the first cell, it may perform downlink reception of the reference signal of the first cell or determine the measurement result of the first cell according to the discovery reference signal.

In some embodiments, in 302, the terminal equipment may determine the measurement result of the first cell according to the discovery reference signal, the measurement result including one of received power (RSRP), received quality (RSRQ), and a signal to interference plus noise ratio (SINR). The terminal equipment performs random access, SSB-based radio link monitoring (RLM), SSB-based beam failure detection (BFD), SSB-based radio resource management (RRM) measurement, and measurement for cell selection and/or reselection in the first cell according to a measurement result obtained by measuring the discovery reference signal.

In some embodiments, in 302, the terminal equipment may perform downlink reception of the reference signal of the first cell according to the discovery reference signal. The reference signal of the first cell includes a CSI-RS, the CSI-RS being in a QCL relationship with the first SSB, that is, the terminal equipment performs downlink reception of the CSI-RS in a quasi-colocation relationship with the first synchronization signal block according to the discovery reference signal, and performs RLM/BFD/RRM measurement or contention-free random access based on the received CSI-RS.

In an aspect, upon receiving the CSI-RS in a quasi-colocation relationship with the first synchronization signal block, the terminal equipment takes a downlink reception parameter for receiving the discovery reference signal as a downlink reception parameter for receiving the CSI-RS in a quasi-colocation relationship with the first synchronization signal block, wherein the downlink reception parameters include a Doppler shift, Doppler spread, average latency, latency spread, and a spatial reception parameter.

In an aspect, the terminal equipment determines that the quasi-colocation relationship between the CSI-RS and the synchronization signal blocks of the first cell is identical to the quasi-colocation relationship between the CSI-RS and the discovery reference signal, and receives the CSI-RS according to the downlink reception parameter for receiving the discovery reference signal, wherein that the quasi-colocation relationships are identical refers to that the CSI-RS and the first SSB are in a quasi-colocation relationship, the discovery reference signal and the first SSB are in a quasi-colocation relationship, and the CSI-RS and the discovery reference signal are also in a quasi-colocation relationship.

Thus, the terminal equipment may perform RLM/BFD/RRM measurement or contention-free random access based on the CSI-RS.

It can be seen from the above embodiments that the terminal equipment may perform downlink reception of the reference signal of the energy-saving cell or determine the measurement result of the energy-saving cell according to the discovery reference signal, and the terminal equipment may perform random access, RLM/BFD/RRM measurement and measurement for cell selection or reselection in the energy-saving cell. Thus, the terminal equipment is not necessarily handed over to other cells, and the terminal equipment originally camping on the energy-saving cell does not necessarily perform cell reselection. This may avoid service interruption and increase of the load level of the neighboring cell resulted from migrating the terminal equipment of the energy-saving cell to the neighboring cell, and ensure that user experiences are not reduced when the cell enters the energy-saving state.

### Embodiments of a Second Aspect

The embodiments of this disclosure provide an information transmitting method, which shall be described from a terminal equipment side, with contents identical to those in the embodiments of the first aspect being not going to be described herein any further.

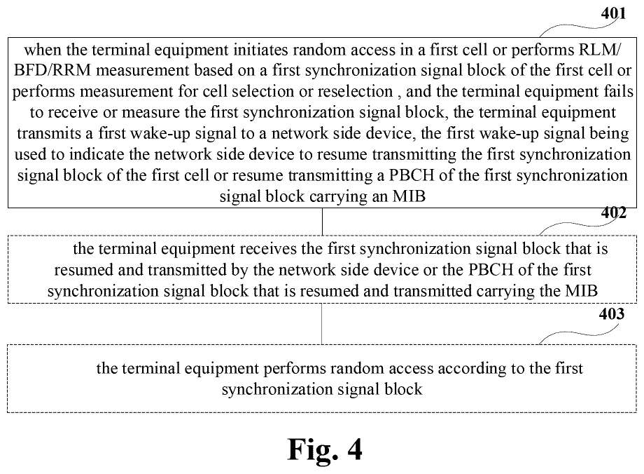

FIG. 4 is a schematic diagram of the information transmitting method of the embodiments of this disclosure. As shown in FIG. 4, the method includes:
401: when the terminal equipment initiates random access in a first cell or performs RLM/BFD/RRM measurement based on a first synchronization signal block of the first cell or performs measurement for cell selection or reselection, and the terminal equipment fails to receive or measure the first synchronization signal block, the terminal equipment transmits a first wake-up signal to a network side device, the first wake-up signal being used to indicate the network side device to resume transmitting the first synchronization signal block of the first cell or resume transmitting a PBCH of the first synchronization signal block carrying an MIB.

In some embodiments, in 401, when the terminal equipment does not receive second indication information transmitted by the network side device and the terminal equipment initiates random access in the first cell or performs RLM/BFD/RRM measurement based on the first synchronization signal block of the first cell or performs cell selection or reselection to the first cell, the terminal equipment transmits the first wake-up signal to the network side device, such as carrying the first wake-up signal by a designated PRACH occasion or random access preamble. Reference may be made to the embodiments of the first aspect for implementation of the second indication information, which shall not be repeated herein any further.

That is, that the terminal equipment does not receive the second indication information indicates that the terminal equipment is unable to perform downlink reception of the reference signal of the first cell or determine the measurement result of the first cell according to the discovery reference signal. If the terminal equipment needs to initiate random access or perform RLM/BFD/RRM measurement based on the first synchronization signal block of the first cell or perform cell selection or reselection to the first cell, it needs to transmit the first wake-up signal to cause the first cell to resume transmission of SSBs or resume transmission of the PBCH of the first synchronization signal block carrying the MIB.

In some embodiments, the method may further include: the terminal equipment transmits a second wake-up signal to the network side device when the terminal equipment fails to receive or measure the second synchronization signal block of the second cell, the second wake-up signal being used to indicate the network side device to resume transmitting the second synchronization signal block of the second cell or resume transmitting a PBCH of the second synchronization signal block carrying an MIB.

The first synchronization signal block of the first cell is in a quasi-colocation (QCL) relationship with the second synchronization signal block of the second cell.

In some embodiments, reference may be made to the embodiments of the first aspect for implementations of the first cell, the second cell, the first SSB and the second SSB, which shall not be repeated herein any further.

In some embodiments, the method may further include: the terminal equipment receives first indication information. Reference may be made to the embodiments of the first aspect for implementation of the first indication information, which shall not be repeated herein any further.

It should be noted that the transmitting objects of the first and second wake-up signals, executing bodies transmitting the first indication information and second indication information, the network device stopping transmitting the first SSB and the network device transmitting the second SSB may be identical or different network devices, and may be identical to or different from the network device transmitting the discovery reference signal.

In some embodiments, the method may further include:
402: the terminal equipment receives the first synchronization signal block that is resumed and transmitted by the network side device or the PBCH of the first synchronization signal block that is resumed and transmitted carrying the MIB; and
403: the terminal equipment performs random access according to the first synchronization signal block, or performs RLM/BFD/RRM measurement according to the first synchronization signal block of the first cell or performs cell selection or reselection to the first cell.

Reference may be made to existing techniques for implementations of 402-403, which shall not be repeated herein any further.

In addition, if the second cell also does not transmit the second SSB or the PBCH carrying the MIB, the terminal equipment may also receive the second synchronization signal block resumed and transmitted by the network side device or the PBCH of the second synchronization signal block resumed and transmitted by the network side device carrying the MIB.

It can be seen from the embodiments of this disclosure that the terminal equipment may transmit the wake-up signal to cause the energy-saving cell that has stopped transmitting SSBs to resume transmission of SSBs or resume transmission of the PBCH of the first SSB carrying the MIB, and based on the SSBs resumed to be transmitted, perform random access, RLM/BFD/RRM measurement, cell selection or reselection, etc., in the energy-saving cell. Hence, the terminal equipment is not necessarily handed over to other cells, and the terminal equipment originally camping on the energy-saving cell does not necessarily perform cell reselection, which may avoid service interruption and increase of the load level of the neighboring cell resulted from migrating the terminal equipment of the energy-saving cell to the neighboring cell.

### Embodiments of a Third Aspect

The embodiments of this disclosure provide an information transmitting method, which is processing at a network device side corresponding to the embodiments of the first and second aspects, with contents identical to those in the embodiments of the first and second aspects being not going to be repeated herein any further.

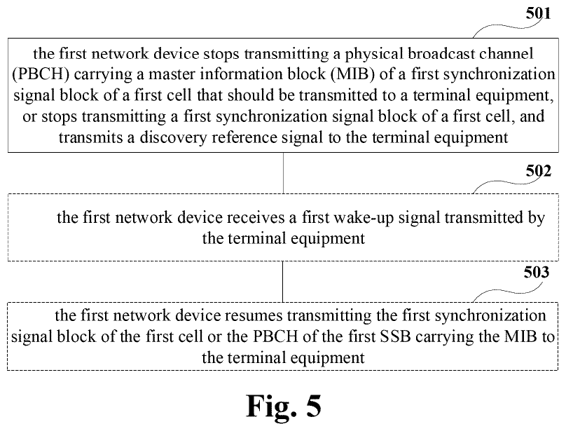

FIG. 5 is a schematic diagram of the information transmitting method of the embodiments of this disclosure, applicable to a first network device to which a first cell belongs. As shown in FIG. 5, the method includes:
501: the first network device stops transmitting a physical broadcast channel (PBCH) carrying a master information block (MIB) of a first synchronization signal block of a first cell that should be transmitted to a terminal equipment, or stops transmitting a first synchronization signal block of a first cell, and transmits a discovery reference signal to the terminal equipment, wherein the discovery reference signal is a synchronization reference signal (SS) contained in the first synchronization signal block of the first cell.

In some embodiments, reference may be made to the embodiments of the first aspect for implementations of the first cell, the second cell, the first SSB and the second SSB, which shall not be repeated herein any further.

In some embodiments, the method may further include: the first network device transmits first indication information to the terminal equipment. Reference may be made to the embodiments of the first aspect for implementation of the first indication information, which shall not be repeated herein any further.

In some embodiments, the first network device transmits second indication information to the terminal equipment. Reference may be made to the embodiments of the first aspect for implementation of the second indication information, which shall not be repeated herein any further.

In some embodiments, in a case where the second indication information is not transmitted, i.e. the terminal equipment is unable to perform downlink reception of the reference signal of the first cell or determine the measurement result of the first cell via the discovery reference signal, the method may further include:
502: the first network device receives a first wake-up signal transmitted by the terminal equipment. Reference may be made to the embodiments of the second aspect for the first wake-up signal, which shall not be repeated herein any further.

In some embodiments, the method further includes:
503: the first network device resumes transmitting the first synchronization signal block of the first cell or the PBCH of the first SSB carrying the MIB to the terminal equipment.

In some embodiments, the network side device resumes transmitting the first synchronization signal block of the first cell before transmitting an RRC reconfiguration message, the RRC reconfiguration message being an RRC reconfiguration message used for master cell group (MCG) or secondary cell group (SCG) resynchronization. As contention-free random access indicated by the RRC reconfiguration message for MCG/SCG resynchronization is initiated by the network side device and the contention-free random access for MCG/SCG resynchronization is unable to be based on a CSI-RS, but only on an SSB, the network device needs to resume transmitting the first SSB before transmitting the RRC reconfiguration message, so that the terminal equipment may complete the contention-free random access indicated by the RRC reconfiguration message for MCG/SCG resynchronization based on the first SSB that is resumed transmitting.

When the second cell is also controlled by the first network device, the first network device may also stop transmitting the physical broadcast channel (PBCH) of the second synchronization signal block of the second cell carrying the master information block (MIB) to the terminal equipment, or stop transmitting the second synchronization signal block of the second cell to the terminal equipment, and receive the second wake-up signal and resume transmitting the second synchronization signal block of the second cell or the PBCH of the second SSB carrying the MIB to the terminal equipment, which shall not be enumerated herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

As described above, if there exists no QCL relationship between the first SSB of the first cell and the reference signal of the second cell (including the second SSB and CSI-RS), the network device may transmit the discovery reference signal to the terminal equipment, and the terminal equipment of the first cell performs downlink reception of the reference signal of the first cell or determines the measurement result of the first cell according to the discovery reference signal, and if there exists a QCL relationship between the first SSB of the first cell and the reference signal of the second cell (including the second SSB and CSI-RS), the terminal equipment of the first cell may perform downlink reception of the reference signal of the first cell or determine the measurement result of the first cell according to the reference signal of the second cell.

Indication Information on whether to stop transmitting SSB may be exchanged between the network devices, and a neighboring base station of the energy-saving cell broadcasts the exchanged information to the terminal equipment via system information, so that a terminal equipment of the neighboring cell may also be able to detect the energy-saving cell, and perform RRM measurement on the energy-saving cell by using the discovery reference signal or the reference signal of the second cell.

In the above embodiments, the information exchange (via an air interface) between terminal equipment and network device and behaviors thereof are described. Information exchange (via Xn interface) between network devices and behaviors thereof shall be described below with reference to embodiments of a fourth and fifth aspects.

### Embodiments of the Fourth Aspect

The embodiments of this disclosure provide an information transceiving method, which shall be described from a side of a first network device to which a first cell belongs.

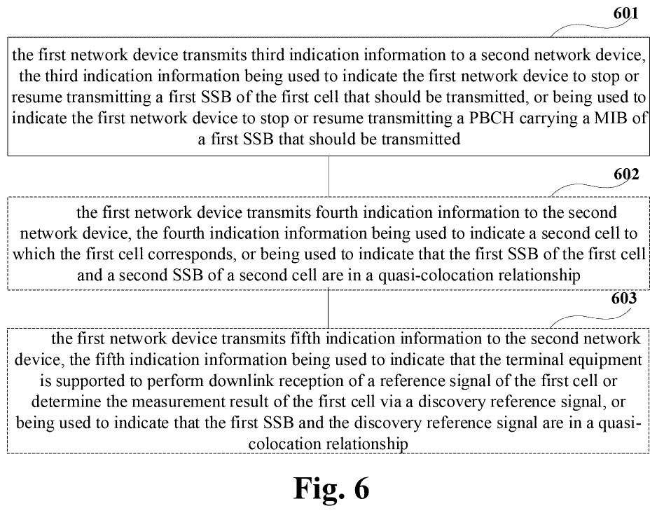

FIG. 6 is a schematic diagram of the information transceiving method of the embodiments of this disclosure. As shown in FIG. 6, the method includes:
601: the first network device transmits third indication information to a second network device, the third indication information being used to indicate the first network device to stop or resume transmitting a first synchronization signal block of the first cell that should be transmitted, or being used to indicate the first network device to stop or resume transmitting a physical broadcast channel (PBCH) carrying a master information block (MIB) of a first synchronization signal block that should be transmitted (herein after referred to as a PBCH of the first SSB).

In some embodiments, via the third indication information, the first network device may inform the second network device of whether the cell controlled thereby stops transmitting the first SSB or the PBCH of the first SSB, or whether the first SSB or the PBCH of the first SSB is resumed transmitting, or whether stopping transmitting the first SSB or the PBCH of the first SSB is changed into resuming transmitting the first SSB or the PBCH of the first SSB, or whether transmitting the first SSB or the PBCH of the first SSB is changed into stopping transmitting the first SSB or the PBCH of the first SSB.

In some embodiments, the third indication information may implicitly indicate by reusing an information element in an existing serving cell information field (Serving Cell Information NR). For example, it may implicitly indicate by reusing an existing information element (ssb-PositionsInBurst) used for indicating a position of an SSB that is actually transmitted. In a bitmap contained in the information element, each bit corresponds to an SSB (SSB index). If a bit value of a bit is 0, it indicates stopping transmitting an SSB or a PBCH of the SSB to which the bit corresponds. If the first cell stops transmitting all SSBs or PBCHs of all SSBs, the bitmap is all zeros. If a bit value of a bit is 1, it indicates normally transmitting an SSB or a PBCH of the SSB to which the bit corresponds. If the first cell transmits all SSBs or PBCHs of all the SSBs, the bitmap is all 1.

In some embodiments, the third indication information may be explicitly indicate via a newly-added information element in a serving cell information field. For example, in the newly-added information element, the number of bits in the newly-added information element may be identical to the number of bits in an information element (ssb-PositionsInBurst), and each bit in a bitmap contained in the newly-added information element corresponds to an SSB (SSB index). If a bit value of a bit is 0, it indicates stopping transmitting the SSB or the PBCH of the SSB that should have been transmitted to which the bit corresponds. If the first cell stops transmitting all SSBs or PBCHs of all SSBs that should actually be transmitted, the bitmap is all zeros. If the bit value of a bit is 1, it indicates normally transmitting the SSB or the PBCH of the SSB to which the bit corresponds. If the first cell transmits all SSBs or PBCHs of all SSBs, the bitmap is all 1. Optionally, the bits in the newly-added information element is valid only when a corresponding bit in the information element (ssb-PositionsInBurst) is 1 (1 represents those that should be actually transmitted). That is, if the information element (ssb-PositionsInBurst) is 001, corresponding to SSB indices 0, 1 and 2 respectively, and the newly-added information element is 101, corresponding to SSB indices 0, 1 and 2 respectively, SSB index 0 is 0 in the information element (ssb-PositionsInBurst), and in the newly-added information element, the bit value 1 to which SSB index 0 corresponds is invalid, and only a bit value to which SSB index 2 corresponds is valid. Or, the number of bits of the newly-added information element may be identical to the number of bits with a bit value of 1 in the information element (ssb-PositionsInBurst). That is, each bit of the newly-added information element corresponds to the SSB indices with a corresponding bit value of 1 in the information element (ssb-PositionsInBurst). If the bit value of a bit is 0, it indicates that the SSB or the PBCH of the SSB that should have been transmitted to which the bit corresponds is stopped transmitting, and if the bit value of a bit is 1, it indicates that the SSB or the PBCH of the SSB to which the bit corresponds is transmitted normally.

In some embodiments, if there exists a QCL relationship between the first SSB of the first cell and the reference signal of the second cell, the method may further include:
602: the first network device transmits fourth indication information to the second network device, the fourth indication information being used to indicate a second cell to which the first cell corresponds, or being used to indicate that the first synchronization signal block of the first cell and a second synchronization signal block of a second cell are in a quasi-colocation relationship, so that a terminal equipment performs downlink reception of a reference signal of the first cell or determines a measurement result of the first cell according to a reference signal of the second cell, wherein the reference signal of the second cell and the reference signal of the first cell include synchronization signal blocks or CSI-RSs.

Thus, the terminal equipment of the neighboring cell may perform downlink synchronization and downlink channel estimation of the first cell or perform RRM measurement of the first cell according to the reference signal of the second cell.

In some embodiments, the fourth indication information indicates by reusing an information element in an existing serving cell information field (Served Cell Information NR), such as implicitly indicating by reusing a measurement timing field in existing measurement timing configuration used for transmitting measurement timing assistance information, the measurement timing field may be expressed as follows by using ASN.1 data format:

MeasTiming ::= SEQUENCE {

| | |
|---|---|
| frequencyAndTiming | SEQUENCE { |
| carrierFreq | ARFCN-ValueNR, |
| ssbSubcarrierSpacing | SubcarrierSpacing, |
| ssb-MeasurementTimingConfiguration | SSB-MTC, |
| ss-RSSI-Measurement | SS-RSSI-Measurement |

```
OPTIONAL
  }
OPTIONAL,
  ...,
  [[
```

| | |
|---|---|
| ssb-ToMeasure | SSB-ToMeasure |

OPTIONAL,

| | |
|---|---|
| physCellId | PhysCellId |

OPTIONAL
]]

wherein, physCellId may indicate the second cell, denoting PCI of the second cell, carrierFreq may indicate an absolute frequency point of the second SSB of the second cell, and ssb-MeasurementTimingConfiguration may indicate measurement timing information used for searching for the second SSB of the second cell.

In some embodiments, an information element may be newly-added into serving cell information of the first cell or serving cell information of the second cell to indicate the second cell. For example, in the serving cell information of the first cell, the newly-added information element indicates an identification (NCGI or PCI) of the second cell, and optionally, it may also indicate the measurement timing information. Or, an information element is newly added into the serving cell information of the second cell to indicate a cell may serve as a second cell of which first cells.

For example, the information element may be a quasi-colocation cell identification information element, which represents the identification of the second cell, and is used to indicate that the first synchronization signal block of the first cell and the second synchronization signal block of the second cell are in a quasi-colocation relationship. For example, in the serving cell information of the first cell, if the newly-added information element indicates the identification (NCGI or PCI) of the second cell, it means that the first SSB of the first cell and the second SSB of the second cell with the identification (with an index identical to that of the first SSB) are in a quasi-colocation relationship.

In some embodiments, if there exists no QCL relationship between the first SSB of the first cell and the reference signal of the second cell, the network device may transmit the discovery reference signal to the terminal equipment, and the method may further include:
603: the first network device transmits fifth indication information to the second network device, the fifth indication information being used to indicate that the terminal equipment is supported to perform downlink reception of a reference signal of the first cell or determine the measurement result of the first cell via a discovery reference signal, or being used to indicate that the first synchronization signal block and the discovery reference signal are in a quasi-colocation relationship.

In some embodiments, the fifth indication information may be a newly-designed information element in the serving cell information field, and by transmitting the fifth indication information, the first network device indicates that the terminal equipment is able to perform downlink reception of the reference signal of the first cell or determine the measurement result of the first cell according to the discovery reference signal. When the fifth indication information is not transmitted, it indicates that the terminal equipment is unable to perform downlink reception of the reference signal of the first cell or determine the measurement result of the first cell according to the discovery reference signal.

In some embodiments, the fifth indication information may include an identification indicating the discovery reference signal, which is used to indicate that the first synchronization signal block of the first cell is in a quasi-colocation relationship with the discovery reference signal. For example, when the second network device receives the fifth indication information, it indicates that the first SSB of the first cell is in a quasi-colocation relationship with the discovery reference signal with the identification, and implicitly indicates that the terminal equipment performs downlink reception of the reference signal of the first cell or determines the measurement result of the first cell according to the discovery reference signal.

Optionally, the fifth indication information may further include configuration information of the discovery reference signal, the configuration information of the discovery reference signal including at least one of a center frequency point of the discovery reference signal, a subcarrier spacing of the discovery reference signal, a transmission period of the discovery reference signal, or an index of a reference signal transmitted within a transmission period. The newly-designed information element is used to indicate the configuration information of the discovery reference signal. When the serving cell information field includes the fifth indication information, it implicitly indicates that the terminal equipment may perform downlink reception of the reference signal of the first cell or determine the measurement result of the first cell according to the discovery reference signal, and the configuration information of the discovery reference signal may be determined according to the fifth indication information.

In some embodiments, the first network device transmits the third indication information, the fourth indication information and/or the fifth indication information to the second network device in an Xn connection establishment procedure, wherein the third indication information and/or the fourth indication information and/or the fifth indication information is/are carried by serving cell information contained in an Xn setup request or Xn setup response message.

In some embodiments, when the first cell changes from transmitting the first SSB into stopping transmitting the first SSB, or changes from stopping transmitting the first SSB to resuming transmitting the first SSB, or when the second cell is updated (the identification of the second cell is updated or a frequency point or measurement timing information of the second cell SSB is changed), or when the configuration information of the discovery reference signal is updated, the first network device transmits the third indication information and/or the fourth indication information and/or the fifth indication information to the second network device in an NG-RAN node configuration update procedure, wherein the third indication information, the fourth indication information and/or the fifth indication information is/are carried by serving cell information contained in an NG-RAN NodeConfiguration Update message.

The above description is given by taking that the first network device notifies the second network device of whether the first cell it controls stops transmitting the first SSB, or the PBCH of the first SSB, or the reference cell (second cell) of the first cell and the discovery reference signal configuration information of the first cell as an example. However, the first cell may be one or more, that is, the first network device may transmit the above information of multiple cells it controls to the second network device, which shall not be enumerated herein any further.

In some embodiments, the first network device may also carry the third indication information and/or the fourth indication information and/or the fifth indication information by the system information of the first cell or a dedicated RRC message and transmit it/them to a first terminal equipment before stopping transmitting the synchronization signal block and the system information or stopping transmitting the physical broadcast channel (PBCH) in the synchronization signal block carrying the master information block (MIB) and the system information, and reference may be made to the transmission mode of the first indication information or the second indication information in the embodiments of the first aspect, which shall not be repeated herein any further. The first terminal equipment may be a terminal equipment of the first cell, and when the second cell is also controlled by the first network device, the first terminal equipment may also be a terminal equipment of the second cell.

In some embodiments, the first network device may also receive an indication transmitted by the second network device indicating whether the cell controlled by the second network device stops transmitting an SSB, or a PBCH of the SSB, or a reference cell of a cell, and configuration information of the discovery reference signal of a cell, etc., implementation thereof being similar to those of the third indication information, the fourth indication information and the fifth indication information, and being not going to be repeated herein any further.

It should be noted that 601-603 may be implemented separately or in a combined manner, and the embodiments of this disclosure are not limited thereto.

It can be seen from the above embodiments that the indication information on whether to stop transmitting SSBs may be exchanged between the network devices, so that the neighboring base station of the energy-saving cell may broadcast the exchanged information to the terminal equipment via the system information, thereby enabling the terminal equipment to detect the energy-saving cell, and perform RRM measurement on the energy-saving cell by using the discovery reference signal or the reference signal of the second cell.

### Embodiments of the Fifth Aspect

The embodiments of this disclosure provide an information transceiving method, which shall be described from a side of a second network device. The second network device may be a network device to which a neighboring cell of a first cell belongs. Following is detailed description.

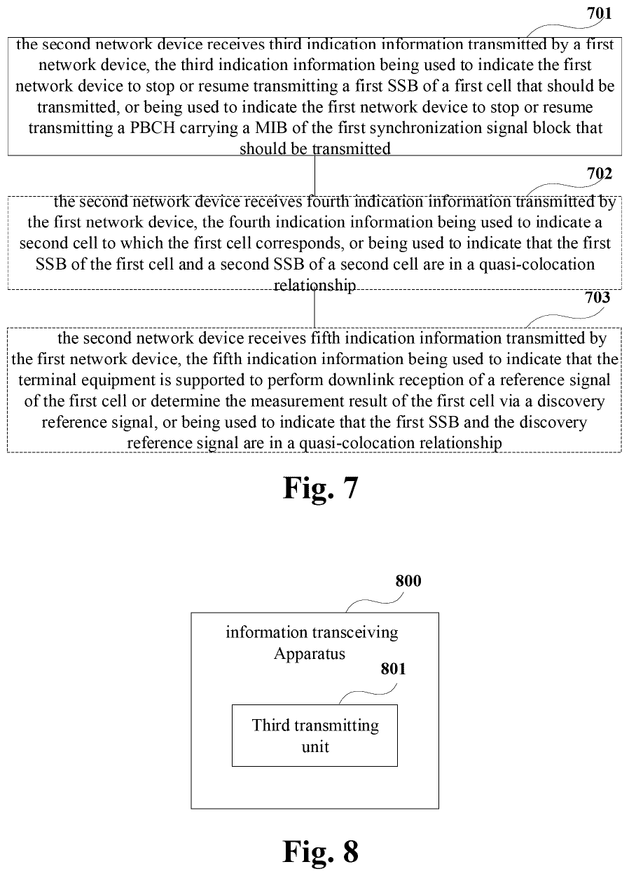

FIG. 7 is a schematic diagram of the information transceiving method of the embodiments of this disclosure. As shown in FIG. 7, the method includes:
701: the second network device receives third indication information transmitted by a first network device, the third indication information being used to indicate the first network device to stop or resume transmitting a first synchronization signal block of a first cell that should be transmitted, or being used to indicate the first network device to stop or resume transmitting a physical broadcast channel (PBCH, hereinafter referred to as a PBCH of the first SBB) carrying a master information block (MIB) of the first synchronization signal block that should be transmitted.

Optionally, the method may further include:
702: the second network device receives fourth indication information transmitted by the first network device, the fourth indication information being used to indicate a second cell to which the first cell corresponds, or being used to indicate that the first synchronization signal block of the first cell and a second synchronization signal block of a second cell are in a quasi-colocation relationship, so that a terminal equipment performs downlink reception of a reference signal of the first cell or determines a measurement result of the first cell according to a reference signal of the second cell, wherein the reference signal of the second cell and the reference signal of the first cell include synchronization signal blocks or CSI-RSs.

Optionally, the method may further include:
703: the second network device receives fifth indication information transmitted by the first network device, the fifth indication information being used to indicate that the terminal equipment is supported to perform downlink reception of a reference signal of the first cell or determine the measurement result of the first cell via a discovery reference signal, or being used to indicate that the first synchronization signal block and the discovery reference signal are in a quasi-colocation relationship.

Reference may be made to 601-603 in the embodiments of the fourth aspect for implementations of 701-703, which shall not be repeated herein any further.

In some embodiments, the method may further include: the second network device transmits the third indication information, the fourth indication information and/or the fifth indication information to a second terminal equipment, the second terminal equipment being a terminal equipment served by the second network device.

In some embodiments, the second network device carries the third indication information and/or the fourth indication information and/or the fifth indication information by system information or a dedicated RRC message.

In some embodiments, the system information is system information of the first cell or system information of a neighboring cell. The system information of the first cell is included in the system information of the neighboring cell, wherein the neighboring cell is a cell controlled by the second network device.

Optionally, when the configuration information of the discovery reference signal indicated by the fifth indication information is broadcast via the system information of the neighboring cell, the configuration information of the discovery reference signal may further include a synchronization timing offset between the first cell and the neighboring cell, in units of half-frames. In some embodiments, the second network device may further transmit an indication to the first network device indicating whether the cell controlled by the second network device stops transmitting an SSB, or a PBCH of an SSB, or a reference cell of a cell, and configuration information of the discovery reference signal of a cell, etc., and implementation thereof is similar to those of the third indication information, the fourth indication information and the fifth indication information, which shall not be repeated herein any further.

It should be noted that 701-703 may be implemented separately or in a combined manner, and the embodiments of this disclosure are not limited thereto.

It can be seen from the above embodiments that the indication information on whether to stop transmitting SSBs may be exchanged between the network devices, so that the neighboring base station of the energy-saving cell may broadcast the exchanged information to the terminal equipment via the system information, thereby enabling the terminal equipment to detect the energy-saving cell, and perform RRM measurement on the energy-saving cell by using the discovery reference signal or the reference signal of the second cell.

### Embodiments of a Sixth Aspect

The embodiments of this disclosure provide an information transceiving apparatus. The apparatus may be, for example, a network device, or one or some components or assemblies configured in the network device. The apparatus in the embodiments corresponds to the methods in the embodiments of the third to fifth aspects, with contents in the embodiments identical to those in the embodiments of the third to fifth aspects being not going to be described herein any further.

FIG. 8 is a schematic diagram of the information transceiving apparatus of the embodiments of this disclosure, applicable to a first network device to which a first cell belongs. As shown in FIG. 8, an information transceiving apparatus 800 includes:
a third transmitting unit 801 configured to stop transmitting a physical broadcast channel (PBCH) carrying a master information block (MIB) of a first synchronization signal block of a first cell, or stop transmitting a first synchronization signal block of a first cell, that should be transmitted to a terminal equipment, and the first network device transmits a discovery reference signal to the terminal equipment,
wherein the discovery reference signal is a synchronization reference signal (SS) contained in the first synchronization signal block of the first cell.

In some embodiments, the first synchronization signal block of the first cell and the discovery reference signal are in a QCL relationship.

In some embodiments, the first synchronization signal block and the discovery reference signal in the quasi-colocation relationship have identical index.

In some embodiments, the third transmitting unit further transmits first indication information and/or second indication information to the terminal equipment, and reference may be made to the embodiments of the first aspect for implementation(s) of the first indication information and/or the second indication information.

In some embodiments, the first cell is a special cell (SpCell) of the terminal equipment when it is in a connected state, or a cell selected or reselected by the terminal equipment when it is in an idle or inactive state.

In some embodiments, the first indication information and/or the second indication information is/are carried by system information of the first cell, or system information of the second cell, or a dedicated RRC message.

In some embodiments, the system information of the first cell is contained in the system information of the second cell.

In some embodiments, the second indication information further includes configuration information of the discovery reference signal, the configuration information of the discovery reference signal including at least one of a center frequency point of the discovery reference signal, a subcarrier spacing of the discovery reference signal, a transmission period of the discovery reference signal, or an index of a reference signal transmitted within a transmission period.

In some embodiments, the configuration information of the discovery reference signal further includes a synchronization timing offset between the first cell and the second cell.

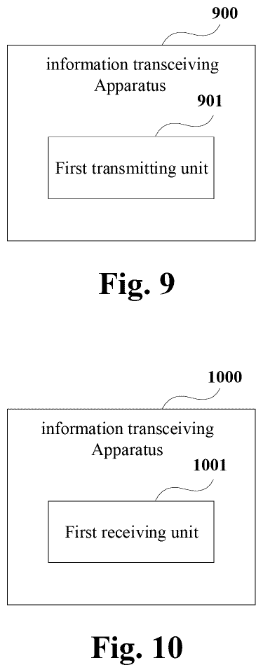

FIG. 9 is a schematic diagram of an example of the information transceiving apparatus of the embodiments of this disclosure, applicable to a first network device to which a first cell belongs.

As shown in FIG. 9, an information transceiving apparatus 900 includes:
a first transmitting unit 901 configured to transmit third indication information to a second network device, the third indication information being used to indicate the first network device to stop or resume transmitting a first synchronization signal block of the first cell that should be transmitted, or being used to indicate the first network device to stop or resume transmitting a physical broadcast channel (PBCH) carrying a master information block (MIB) of a first synchronization signal block that should be transmitted.

In some embodiments, the first transmitting unit is further configured to transmit fourth indication information and/or fifth indication information to the second network device, and reference may be made to the embodiments of the fourth and fifth aspects for implementation(s) of the third indication information and/or the fourth indication information and/or the fifth indication information, which shall not be repeated herein any further.

In some embodiments, the first transmitting unit transmits the third indication information, the fourth indication information and/or the fifth indication information to the second network device during an Xn connection establishment procedure, wherein the third indication information and/or the fourth indication information and/or the fifth indication information is/are carried by serving cell information contained in an Xn setup request or Xn setup response message.

In some embodiments, the first transmitting unit transmits the third indication information and/or the fourth indication information and/or the fifth indication information to the second network device during an NG-RAN node configuration update procedure, wherein the third indication information, the fourth indication information and/or the fifth indication information is/are carried by serving cell information contained in an NG-RAN node configuration update message.

In some embodiments, the first transmitting unit further transmits the third indication information and/or the fourth indication information and/or the fifth indication information to a first terminal equipment.

In some embodiments, before the first network device stops transmitting a synchronization signal block and system information or before the first network device stops transmitting a physical broadcast channel (PBCH) of the synchronization signal block carrying a master information block (MIB) and system information, the first transmitting unit carries the third indication information and/or the fourth indication information and/or the fifth indication information by the system information of the first cell or a dedicated RRC message and transmits the third indication information and/or the fourth indication information and/or the fifth indication information.

FIG. 10 is a schematic diagram of an example of the information transceiving apparatus of the embodiments of this disclosure, applicable to a second network device. As shown in FIG. 10, an information transceiving apparatus 1000 includes:
a first receiving unit 1001 configured to receive third indication information transmitted by a first network device, the third indication information being used to indicate the first network device to stop or resume transmitting a first synchronization signal block of a first cell that should be transmitted, or being used to indicate the first network device to stop or resume transmitting a physical broadcast channel (PBCH, hereinafter referred to as a PBCH of the first SBB) carrying a master information block (MIB) of the first synchronization signal block that should be transmitted.

In some embodiments, the first receiving unit further receives fourth indication information and/or fifth indication information transmitted by the first network device, and reference may be made to the embodiments of the fourth and fifth aspects for implementation(s) of the third indication information and/or the fourth indication information and/or the fifth indication information, which shall not be repeated herein any further.

In some embodiments, the apparatus may further include (not shown):
a second transmitting unit configured to transmit the third indication information and/or the fourth indication information and/or the fifth indication information to a second terminal equipment.

In some embodiments, the second transmitting unit carries the third indication information and/or the fourth indication information and/or the fifth indication information in system information or a dedicated RRC message.

In some embodiments, the system information is system information of the first cell, or system information of the second cell or a neighboring cell.

In some embodiments, the system information of the first cell is contained in the system information of the second cell or a neighboring cell.

In some embodiments, the first receiving unit receives the third indication information, the fourth indication information and/or the fifth indication information during an Xn connection setup procedure, wherein the third indication information and/or the fourth indication information and/or the fifth indication information is/are carried by serving cell information contained in an Xn setup request or Xn setup response message.

In some embodiments, the first receiving unit receives the third indication information and/or the fourth indication information and/or the fifth indication information during an NG-RAN node configuration update procedure, wherein the third indication information, the fourth indication information and/or the fifth indication information is/are carried by serving cell information contained in an NG-RAN node configuration update message.

In some embodiments, the third indication information, the fourth indication information and/or the fifth indication information reuse(s) an information element in an existing serving cell information field or is/are a newly-added information element(s).

In some embodiments, the configuration information of the discovery reference signal further includes a synchronization timing offset between the first cell and the second cell.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatuses 800-1000 may further include other components or modules, and reference may be made to related techniques for particulars of these components or modules. Furthermore, the above components or modules may be implemented by hardware, such as a processor, a memory, a transmitter, and a receiver, etc., which are not limited in the embodiments of this disclosure.

### Embodiments of a Seventh Aspect

The embodiments of this disclosure provide an information processing apparatus. The apparatus may be, for example, a terminal equipment, or one or some components or assemblies configured in the terminal equipment. The apparatus in the embodiments corresponds to the method in the embodiments of the second aspect, with contents in the embodiments identical to those in the embodiments of the second aspect being not going to be described herein any further.

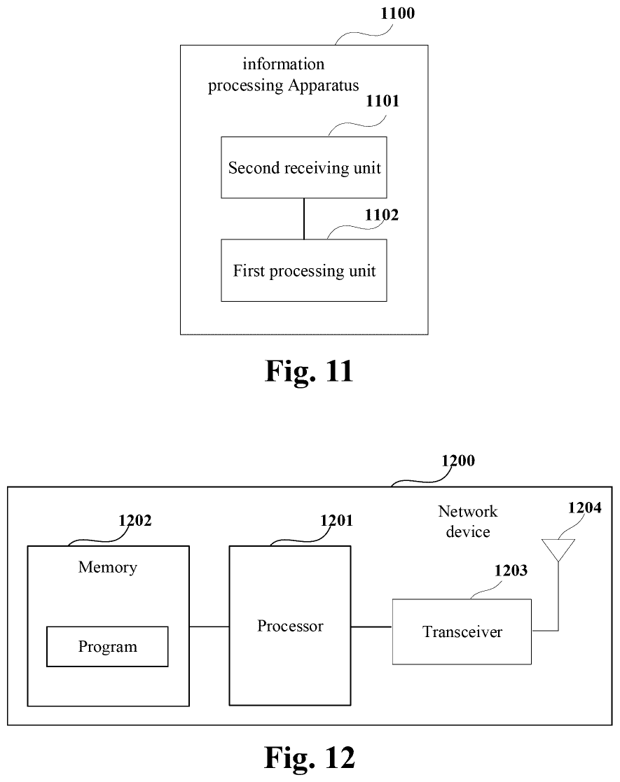

FIG. 11 is a schematic diagram of the information processing apparatus of the embodiments of this disclosure. As shown in FIG. 11, an information processing apparatus 1100 includes:
a second receiving unit 1101 configured to receive a discovery reference signal transmitted by a network side device; and
a first processing unit 1102 configured to perform downlink reception of a reference signal of a first cell or determine a measurement result of a first cell according to the discovery reference signal;
wherein the discovery reference signal is a synchronization reference signal (SS) contained in a first synchronization signal block of the first cell.

In some embodiments, when the second receiving unit fails to receive the first synchronization signal block of the first cell transmitted by the network side device or is fails to receive the PBCH of the first synchronization signal block, the first processing unit performs downlink reception of the reference signal of the first cell or determines the measurement result of the first cell according to the discovery reference signal.

In some embodiments, the first synchronization signal block of the first cell and the discovery reference signal are in a QCL relationship.

In some embodiments, the first synchronization signal block and the discovery reference signal in the quasi-colocation relationship have identical index.

In some embodiments, the second receiving unit further receives first indication information and/or second indication information transmitted by the network side device, and reference may be made to the embodiments of the first aspect for implementation(s) of the first indication information and/or the second indication information.

In some embodiments, the first cell is a special cell (SpCell) of the terminal equipment when it is in a connected state, or a cell selected or reselected by the terminal equipment when it is in an idle or inactive state.

In some embodiments, the second receiving unit receives the first indication information and/or the second indication information transmitted by the network device to which the first cell belongs, or receives the first indication information and/or the second indication information forwarded by a neighboring network device of the network device to which the first cell belongs.

In some embodiments, the first indication information and/or the second indication information is/are carried by the system information of the first cell, the system information of the second cell, system information of the neighboring cell, or a dedicated RRC message.

In some embodiments, the system information of the first cell is contained in the system information of the second cell or the system information of the neighboring cell.

In some embodiments, the second indication information further includes configuration information of the discovery reference signal, wherein the configuration information of the discovery reference signal includes at least one of a center frequency point, a subcarrier spacing, a transmission period of the discovery reference signal, or an index of a reference signal transmitted within a transmission period.

In some embodiments, the configuration information of the discovery reference signal further includes a synchronization timing offset between the first cell and the second cell or the neighboring cell.

In some embodiments, the first processing unit performs random access, radio link monitoring based on an SSB, beam failure detection (BFD) based on an SSB, radio resource management (RRM) measurement based on an SSB, cell selection and/or reselection in the first cell according to a measurement result obtained by performing measurement on the discovery reference signal.

In some embodiments, the first processing unit performs downlink reception of a CSI-RS that is in a quasi-colocation relationship with the first synchronization signal block according to the discovery reference signal.

In some embodiments, in receiving the CSI-RS that is in a quasi-colocation relationship with the first synchronization signal block, the first processing unit takes a downlink reception parameter for receiving the discovery reference signal as a downlink reception parameter for receiving the CSI-RS that is in a quasi-colocation relationship with the first synchronization signal block.

In some embodiments, the first processing unit determines that the quasi-colocation relationship between the CSI-RS and a synchronization signal block of the first cell is identical to a quasi-colocation relationship between the CSI-RS and the discovery reference signal, and receives the CSI-RS according to the downlink reception parameter for receiving the discovery reference signal.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the information transceiving apparatus 1100 may further include other components or modules, and reference may be made to related techniques for particulars of these components or modules. Furthermore, the above components or modules may be implemented by hardware, such as a processor, a memory, a transmitter, and a receiver, etc., which are not limited in the embodiments of this disclosure.

### Embodiments of an Eighth Aspect

The embodiments of this disclosure provide a communication system, including a network device and a terminal equipment.

In some embodiments, the network device includes the apparatus described in the embodiments of the sixth aspect, and is configured to carry out the method described in the embodiments of the third or the fourth or the fifth aspect. As the method has been described in detail in the embodiments of the third or the fourth or the fifth aspect, the contents of which are incorporated herein, and shall not be described herein any further.

In some embodiments, the terminal equipment includes the apparatus described in the embodiment of the seventh aspect, and is configured to carry out the method described in the embodiment of the first aspect. As the method has been described in detail in the embodiment of the first aspect, the contents of which are incorporated herein, and shall not be described herein any further.

The embodiments of this disclosure further provide a network device, which may be, for example, a gNB (a base station in NR), etc.

FIG. 12 is a schematic diagram of the network device of the embodiments of this disclosure. As shown in FIG. 12, a network device 1200 may include a central processing unit (CPU) 1201 and a memory 1202, the memory 1202 being coupled to the central processing unit 1201. The memory 1202 may store various data, and furthermore, it may store a program for information processing, and execute the program under control of the central processing unit 1201, so as to receive various information transmitted by a terminal equipment, and transmit various information to the terminal equipment.

In some embodiments, the functions of the apparatus described in the embodiments of the sixth aspect may be integrated into the central processing unit 1201, and the central processing unit 1201 may be configured to carry out the method described in the embodiments of the fourth or the fifth or the third aspect, the contents of which being incorporated herein, which shall not be described herein any further.

In some other embodiments, the apparatus described in the embodiments of the sixth aspect and the central processing unit 1201 may be configured separately; for example, the apparatus described in the embodiments of the sixth aspect may be configured as a chip connected to the central processing unit 1201, and the functions of the apparatus described in the embodiments of the sixth aspect are executed under control of the central processing unit 1201.

Furthermore, as shown in FIG. 12, the network device 1200 may include a transceiver 1203, and an antenna 1204, etc. Functions of the above components are similar to those in the related art, and shall not be described herein any further. It should be noted that the network device 1200 does not necessarily include all the parts shown in FIG. 12, and furthermore, the network device 1200 may include parts not shown in FIG. 12, and the related art may be referred to.

The embodiments of this disclosure further provide a terminal equipment, such as a UE.

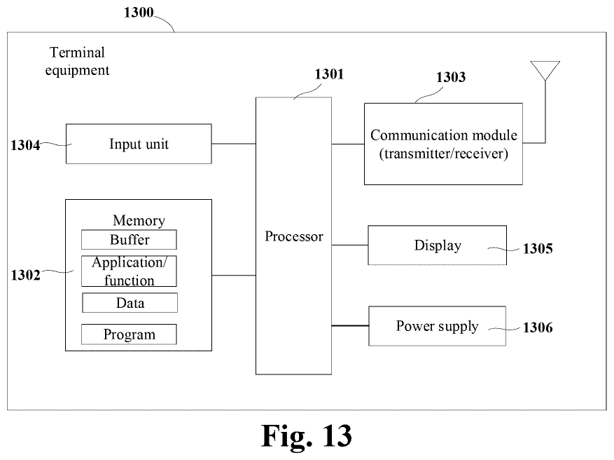

FIG. 13 is a schematic diagram of the terminal equipment of the embodiments of this disclosure. As shown in FIG. 13, a terminal equipment 1300 may include a processor 1301 and a memory 1302, the memory 1302 storing data and a program and being coupled to the processor 1301. It should be noted that this figure is illustrative only, and other types of structures may also be used, so as to supplement or replace this structure and achieve a telecommunications function or other functions.

In some embodiments, the functions of the apparatus described in the embodiments of the seventh aspect may be integrated into the processor 1301, and the processor 1301 may be configured to execute a program to carry out the method described in the embodiments of the first aspect, the contents of which being incorporated herein, which shall not be described herein any further.

In some other embodiments, the apparatus described in the embodiments of the seventh aspect and the processor 1301 may be configured separately; for example, the apparatus described in the embodiments of the seventh aspect may be configured as a chip connected to the processor 1301, and the functions of the apparatus described in the embodiments of the seventh aspect are executed under control of the processor 1301.

As shown in FIG. 13, the terminal equipment 1300 may further include a communication module 1303, an input unit 1304, a display 1305, and a power supply 1306, wherein functions of the above components are similar to those in the related art, which shall not be described herein any further. It should be noted that the terminal equipment 1300 does not necessarily include all the parts shown in FIG. 13, and the above components are not necessary. Furthermore, the terminal equipment 1300 may include parts not shown in FIG. 13, and the related art may be referred to.

Embodiments of this disclosure provide a computer readable program, which, when executed in a terminal equipment, causes the terminal equipment to carry out the method as described in the embodiments of the first aspect.

Embodiments of this disclosure provide a computer storage medium, including a computer readable program, which causes a terminal equipment to carry out the method as described in the embodiments of the first aspect.

Embodiments of this disclosure provide a computer readable program, which, when executed in a network device, causes the network device to carry out the method as described in the embodiments of the third or the fourth or the fifth aspect.

Embodiments of this disclosure provide a computer storage medium, including a computer readable program, which causes a network device to carry out the method as described in the embodiments of the third or the fourth or the fifth aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application.

And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. An information processing method, applicable to a terminal equipment, characterized in that the method includes:
receiving, by the terminal equipment, a discovery reference signal transmitted by a network side device; and
performing downlink reception of a reference signal of a first cell or determining a measurement result of a first cell according to the discovery reference signal;
wherein the discovery reference signal is a synchronization reference signal (SS) contained in a first synchronization signal block of the first cell.

2. The method according to supplement 1, wherein the method further includes:
when the terminal equipment fails to receive the first synchronization signal block of the first cell transmitted by the network side device or fails to receive the PBCH of the first synchronization signal block, performing downlink reception of the reference signal of the first cell or determining the measurement result of the first cell by the terminal equipment according to the discovery reference signal.

3. The method according to supplement 1 or 2, wherein the first synchronization signal block of the first cell and the discovery reference signal are in a QCL relationship.

4. The method according to any one of supplements 1-3, wherein the first synchronization signal block and the discovery reference signal in the quasi-colocation relationship have identical index.

5. The method according to any one of supplements 1-4, wherein the method further includes: receiving, by the terminal equipment, first indication information transmitted by the network side device, the first indication information being used to indicate stopping transmitting the first synchronization signal block of the first cell that should have been transmitted, or indicate stopping transmitting the PBCH of the first synchronization signal block that should have been transmitted carrying the MIB.

6. The method according to supplement 5, wherein the first indication information is further used to indicate an index of the first synchronization signal block that is stopped transmitting and should have been transmitted, or an index of the first synchronization signal block of which the PBCH carrying the MIB that is stopped transmitting and should have been transmitted.

7. The method according to any one of supplements 1-6, wherein the method further includes: receiving, by the terminal equipment, second indication information transmitted by the network side device, the second indication information being used to indicate that the terminal equipment performs downlink reception of the reference signal of the first cell or determines the measurement result of the first cell according to the discovery reference signal, or indicate that the first synchronization signal block is in a quasi-colocation relationship with the discovery reference signal.

8. The method according to any one of supplements 1-7, wherein the first cell is a special cell (SpCell) of the terminal equipment when it is in a connected state, or a cell selected or reselected by the terminal equipment when it is in an idle or inactive state.

9. The method according to any one of supplements 5-7, wherein, the terminal equipment receives the first indication information and/or the second indication information transmitted by the network device to which the first cell belongs, or the terminal equipment receives the first indication information and/or the second indication information forwarded by a neighboring network device of the network device to which the first cell belongs.

10. The method according to any one of supplements 7-9, wherein the second indication information further includes configuration information of the discovery reference signal, wherein the configuration information of the discovery reference signal includes at least one of a center frequency point, a subcarrier spacing, a transmission period, of the discovery reference signal, or an index of a reference signal transmitted within a transmission period.

11. The method according to supplement 10, wherein configuration information of the discovery reference signal further includes a synchronization timing offset between the first cell and the second cell or a neighboring cell.

12. The method according to any one of supplements 1-11, wherein that the terminal equipment determines the measurement result of the first cell according to the discovery reference signal includes that:
the terminal equipment performs random access, SSB-based radio link monitoring (RLM), SSB-based beam failure detection (BFD), SSB-based radio resource management (RRM) measurement, and cell selection and/or reselection measurement in the first cell according to a measurement result obtained by measuring the discovery reference signal.

13. The method according to any one of supplements 1-11, wherein that the terminal equipment performs downlink reception of the reference signal of the first cell according to the discovery reference signal includes that:
the terminal equipment performs downlink reception of the CSI-RS in a quasi-colocation relationship with the first synchronization signal block according to the discovery reference signal.

14. The method according to supplement 13, wherein,
upon receiving the CSI-RS in a quasi-colocation relationship with the first synchronization signal block, the terminal equipment takes a downlink reception parameter for receiving the discovery reference signal as a downlink reception parameter for receiving the CSI-RS in a quasi-colocation relationship with the first synchronization signal block.

15. The method according to supplement 13, wherein,
the terminal equipment determines that the quasi-colocation relationship between the CSI-RS and the synchronization signal blocks of the first cell is identical to the quasi-colocation relationship between the CSI-RS and the discovery reference signal, and receives the CSI-RS according to the downlink reception parameter for receiving the discovery reference signal.

16. A terminal equipment, including a memory and a processor, the memory storing a computer program, and the processor being configured to execute the computer program to carry out the method as described in any one of supplements 1-15.

17. A communication system, including the terminal equipment as described in supplement 16.

### Network Side

1. An information transceiving method, applicable to a first network device to which a first cell belongs, characterized in that the method includes:
stopping transmitting to a terminal equipment a physical broadcast channel (PBCH) carrying a master information block (MIB) of a first synchronization signal block of a first cell that should be transmitted, or stopping transmitting to a terminal equipment a first synchronization signal block of a first cell that should be transmitted, by the first network device, and transmitting a discovery reference signal to the terminal equipment by the first network device;
wherein the discovery reference signal is a synchronization reference signal (SS) contained in the first synchronization signal block of the first cell.

2. The method according to supplement 1, wherein the first synchronization signal block of the first cell and the discovery reference signal are in a QCL relationship.

3. The method according to supplement 1 or 2, wherein the first synchronization signal block and the discovery reference signal in the quasi-colocation relationship have identical index.

4. The method according to any one of supplements 1-3, wherein the method further includes:
transmitting first indication information by the first network device to the terminal equipment, the first indication information being used to indicate stopping transmitting the first synchronization signal block of the first cell that should have been transmitted, or indicate stopping transmitting the PBCH carrying the MIB of the first synchronization signal block that should have been transmitted.

5. The method according to supplement 4, wherein the first indication information is further used to indicate an index of the first synchronization signal block that is stopped transmitting and should have been transmitted, or an index of the first synchronization signal block of which the PBCH carrying the MIB that is stopped transmitting and should have been transmitted.

6. The method according to any one of supplements 1-5, wherein the method further includes:
transmitting second indication information by the network side device to the terminal equipment, the second indication information being used to indicate that the terminal equipment performs downlink reception of the reference signal of the first cell or determines the measurement result of the first cell according to the discovery reference signal, or indicate that the first synchronization signal block is in a quasi-colocation relationship with the discovery reference signal.

7. The method according to any one of supplements 1-6, wherein the first cell is a special cell (SpCell) of the terminal equipment when it is in a connected state, or a cell selected or reselected by the terminal equipment when it is in an idle or inactive state.

8. The method according to any one of supplements 5-7, wherein the first indication information and/or the second indication information is/are carried by system information of the first cell, or system information of the second cell, or a dedicated RRC message.

9. The method according to supplement 8, wherein the system information of the first cell is contained in the system information of the second cell.

10. The method according to any one of supplements 6-9, wherein the second indication information further includes configuration information of the discovery reference signal, the configuration information of the discovery reference signal including at least one of a center frequency point, a subcarrier spacing, a transmission period, of the discovery reference signal or an index of a reference signal transmitted within a transmission period.

11. The method according to supplement 10, wherein the configuration information of the discovery reference signal further includes a synchronization timing offset between the first cell and the second cell.

12. A network device, including a memory and a processor, the memory storing a computer program, and the processor being configured to execute the computer program to carry out the method as described in any one of supplements 1-11.

13. A communication system, including the network device as described in supplement 12.

### Xn Interface

1. An information transceiving method, applicable to a first network device to which a first cell belongs, characterized in that the method includes:
transmitting third indication information by the first network device to a second network device, the third indication information being used to indicate the first network device to stop or resume transmitting a first synchronization signal block of the first cell that should be transmitted, or being used to indicate the first network device to stop or resume transmitting a physical broadcast channel (PBCH) carrying a master information block (MIB) of a first synchronization signal block that should be transmitted.

2. The method according to supplement 1, wherein the method further includes:
transmitting fourth indication information by the first network device to the second network device, the fourth indication information being used to indicate a second cell to which the first cell corresponds, or being used to indicate that the first synchronization signal block of the first cell and a second synchronization signal block of a second cell are in a quasi-colocation relationship, so that a terminal equipment performs downlink reception of a reference signal of the first cell or determines a measurement result of the first cell according to a reference signal of the second cell.

3. The method according to supplement 1, wherein the method further includes:
transmitting fifth indication information by the first network device to the second network device, the fifth indication information being used to indicate that the terminal equipment is supported to perform downlink reception of a reference signal of the first cell or determine the measurement result of the first cell via a discovery reference signal, or being used to indicate that the first synchronization signal block and the discovery reference signal are in a quasi-colocation relationship.

4. The method according to supplement 3, wherein the fifth indication information further includes configuration information of the discovery reference signal, the configuration information of the discovery reference signal including at least one of a center frequency point, a subcarrier spacing, a transmission period, of the discovery reference signal or an index of a reference signal transmitted within a transmission period.

5. The method according to any one of supplements 1-4, wherein the first network device transmits the third indication information, the fourth indication information and/or the fifth indication information to the second network device during an Xn connection establishment procedure, wherein the third indication information and/or the fourth indication information and/or the fifth indication information is/are carried by serving cell information contained in an Xn setup request or Xn setup response message.

6. The method according to any one of supplements 1-4, wherein, the first network device transmits the third indication information and/or the fourth indication information and/or the fifth indication information to the second network device during an NG-RAN node configuration update procedure, wherein the third indication information, the fourth indication information and/or the fifth indication information is/are carried by serving cell information contained in an NG-RAN node configuration update message.

7. The method according to supplement 5 or 6, wherein the third indication information and/or the fourth indication information and/or the fifth indication information reuse(s) an information element in an existing serving cell information field or is/are a newly-added information element(s).

8. The method according to supplement 1, wherein the method further includes:
transmitting the third indication information and/or the fourth indication information and/or the fifth indication information by the first network device to a first terminal equipment.

9. The method according to supplement 8, wherein the first network device carries the third indication information and/or the fourth indication information and/or the fifth indication information by the system information of the first cell or a dedicated RRC message and transmit it/them before stopping transmitting the synchronization signal block and the system information or stopping transmitting the physical broadcast channel (PBCH) in the synchronization signal block carrying the master information block (MIB) and the system information.

10. A method for transceiving information, applicable to a second network device, characterized in that the method includes:
receiving, by the second network device, third indication information transmitted by a first network device, the third indication information being used to indicate the first network device to stop or resume transmitting a first synchronization signal block of a first cell that should be transmitted, or being used to indicate the first network device to stop or resume transmitting a physical broadcast channel (PBCH) carrying a master information block (MIB) of the first synchronization signal block that should be transmitted.

11. The method according to supplement 10, wherein the method further includes:
receiving, by the second network device, fourth indication information transmitted by the first network device, the fourth indication information being used to indicate a second cell to which the first cell corresponds, or being used to indicate that the first synchronization signal block of the first cell and the second synchronization signal block of a second cell are in a quasi-colocation relationship, so that a terminal equipment performs downlink reception of a reference signal of the first cell or determines a measurement result of the first cell via a reference signal of the second cell.

12. The method according to supplement 10, wherein the method further includes:
receiving, by the second network device, fifth indication information transmitted by the first network device, the fifth indication information being used to indicate that a terminal equipment is supported to perform downlink reception of a reference signal of the first cell or determine the measurement result of the first cell via a discovery reference signal, or being used to indicate that the first synchronization signal block and the discovery reference signal are in a quasi-colocation relationship.

13. The method according to supplement 10 or 11, wherein the method further includes: transmitting the third indication information, the fourth indication information and/or the fifth indication information by the second network device to a second terminal equipment.

14. The method according to supplement 13, wherein the second network device carries the third indication information and/or the fourth indication information and/or the fifth indication information by system information or a dedicated RRC message.

15. The method according to supplement 12, wherein the fifth indication information further includes configuration information of the discovery reference signal, the configuration information of the discovery reference signal including at least one of a center frequency point, a subcarrier spacing, a transmission period, of the discovery reference signal or an index of a reference signal transmitted within a transmission period.

16. The method according to any one of supplements 10-15, wherein the second network device receives the third indication information, the fourth indication information and/or the fifth indication information during an Xn connection establishment procedure, wherein the third indication information and/or the fourth indication information and/or the fifth indication information is/are carried by serving cell information contained in an Xn setup request or Xn setup response message.

17. The method according to any one of supplements 10-15, wherein, the second network device receives the third indication information and/or the fourth indication information and/or the fifth indication information during an NG-RAN node configuration update procedure, wherein the third indication information, the fourth indication information and/or the fifth indication information is/are carried by serving cell information contained in an NG-RAN node configuration update message.

18. The method according to supplement 16 or 17, wherein the third indication information and/or the fourth indication information and/or the fifth indication information reuse(s) an information element in an existing serving cell information field or is/are a newly-added information element(s).

19. The method according to supplement 15, wherein configuration information of the discovery reference signal further includes a synchronization timing offset between the first cell and the second cell.

20. A network device, including a memory and a processor, the memory storing a computer program, and the processor being configured to execute the computer program to carry out the method as described in any one of supplements 1-19.

21. A communication system, including the network device as described in supplement 20.

1. An information transceiving apparatus, applicable to a first network device to which a first cell belongs, the apparatus comprising:
a transmitter configured to transmit third indication information to a second network device, the third indication information being used to indicate the first network device to transmit a first synchronization signal block (SSB) of the first cell that should be transmitted.

2. The apparatus according to claim 1, wherein the third indication information indicates an SSB index of the first SSB.

3. The apparatus according to claim 1, wherein a number of the first cell(s) in the third indication information is one or more.

4. The apparatus according to claim 1, wherein the transmitter transmits the third indication information to the second network device during an Xn procedure, wherein the third indication information is carried by an Xn message.

5. The apparatus according to claim 1, wherein the transmitter transmits the third indication information, the fourth indication information and/or the fifth indication information to the second network device during an Xn connection establishment procedure, wherein the third indication information and/or the fourth indication information and/or the fifth indication information is/are carried by serving cell information contained in an Xn setup request or Xn setup response message.

6. The apparatus according to claim 1, wherein,
the transmitter transmits the third indication information and/or the fourth indication information and/or the fifth indication information to the second network device during an NG-RAN node configuration update procedure, wherein the third indication information, the fourth indication information and/or the fifth indication information is/are carried by serving cell information contained in an NG-RAN node configuration update message.

7. An apparatus for transceiving information, applicable to a second network device, the apparatus comprising:
a receiver configured to receive third indication information transmitted by a first network device, the third indication information being used to indicate the first network device to transmit a first synchronization signal block (SSB) of a first cell that should be transmitted.

8. The apparatus according to claim 7, wherein the third indication information indicates an SSB index of the first SSB.

9. The apparatus according to claim 7, wherein a number of the first cell(s) in the third indication information is one or more.

10. The apparatus according to claim 7, wherein the receiver receives the third indication information during an Xn procedure, wherein the third indication information is carried by an Xn message.

11. The apparatus according to claim 7, wherein the receiver receives the third indication information, the fourth indication information and/or the fifth indication information during an Xn connection setup procedure, wherein the third indication information and/or the fourth indication information and/or the fifth indication information is/are carried by serving cell information contained in an Xn setup request or Xn setup response message.

12. The apparatus according to claim 7, wherein,
the receiver receives the third indication information and/or the fourth indication information and/or the fifth indication information during an NG-RAN node configuration update procedure, wherein the third indication information, the fourth indication information and/or the fifth indication information is/are carried by serving cell information contained in an NG-RAN node configuration update message.

13. A communicating system, comprising a first network device and a second network device, wherein,
the first network device is configured to transmit third indication information to the second network device, the third indication information being used to indicate the first network device to transmit a first synchronization signal block (SSB) of the first cell that should be transmitted.
